(19) United States
(12) Patent Application Publication
(10) Pub. No.: US 2002/0112963 A1
(43) Pub. Date: Aug. 22, 2002

(54) Methods for fabricating high-precision thermally stable electromagnetic coils

(75) Inventors: Katsushi Nakano, Kumagaya-shi (JP); Ichiro Ono, Tokyo (JP); Masami Masuko, Yokshomashi (JP); Akira Okada, Yotsukaidoshi (JP)

Correspondence Address: KLARQUIST SPARKMAN, LLP, One World Trade Center, Suite 1600, 121 S. W. Salmon Street, Portland, OR, 97204-2988, US

(73) Assignee: Nikon Corporation

(21) Appl. No.: 10/080,885

(22) Filed: Feb. 22, 2002

(30) Foreign Application Priority Data
Feb. 22, 2001 (JP) 2001-046002
Mar. 1, 2001 (JP) 2001-056098

(51) Int. Cl. B05D 5/12; C25D 5/02; C23C 28/00

(52) U.S. Cl. 205/118; 427/116; 205/223; 205/222; 205/220

(57) ABSTRACT

Methods are disclosed for manufacturing coils for use in a charged-particle-beam (CPB) optical system such as would be used in a CPB imaging apparatus or CPB lithography apparatus. In an embodiment, on a surface of a coil substrate is formed a mask layer defining channels corresponding to a coil pattern. Using the mask layer as a mask, a pattern of conductive coil-forming material is applied to the substrate surface in the channels. Coil elements formed on the substrate surface by this method exhibit steep sides and a desired aspect ratio. To such end, the depth of the channels desirably is greater than the desired thickness of the coil elements. Alternatively, a metal layer (for use as an electroplating electrode) is formed on a surface of the substrate. The metal layer is coated with a resist at a thickness of at least 0.1 mm. The resist is removed by lithography from regions where coil elements are to be formed. In the regions, conductive metal is grown by electroplating to form the coil elements.

### FIELD

This disclosure pertains to, inter alia, charged-particle-beam (CPB) “optical” systems for use with a charged particle beam such as an ion beam or electron beam. The CPB optical systems are especially suitable for use in apparatus configured for observations (e.g., microscopic observations) or for making lithographic exposures (e.g., microlithography as used in fabricating microelectronic devices). More specifically, the disclosure is directed to methods for manufacturing coils as used in lenses and deflectors in CPB optical systems.

### BACKGROUND

The progressive miniaturization of microelectronic devices in recent years has been realized in part by the development of lithographic tools capable of achieving progressively higher pattern resolution. In this regard, a key development in lithographic technology has been the debut of microlithography apparatus that employ a charged particle beam (e.g., electron beam) instead of a beam of light (typically deep UV light). Other contemporaneous developments have occurred in microscope technology in which a charged particle beam such as an electron beam or focused ion beam is utilized, and in precision-machining devices that utilize such a beam.

An electron beam generally has better linearity than a beam of light. Consequently, in microlithographic exposures for example, an electron beam has the potential of producing a finer projected pattern than achievable using a beam of light. Furthermore, as a consequence of extensive technical development of electron microscopes and the like, the technology of condensing and deflecting an electron beam is highly developed. An electron beam is condensed typically using one or more electromagnetic lenses. In an electromagnetic lens, electrical current is passed through a coil in the lens. The energized coil generates a corresponding magnetic field that usually is centered on the optical axis of the lens. The trajectory of individual charged particles of the beam is changed or otherwise controlled by the Lorentz force produced by the energized coil.

More recently, the demands for ever-finer pattern linewidth have become more extreme. Consequently, current CPB microlithography apparatus must operate at exhibit extremely high performance levels, which imposes extremely strict configurational and operational tolerances on various components of the CPB optical system. For example, coils currently are manufactured by winding copper wire around a bobbin. Winding a wire coil inevitably results in certain variations in the positional accuracy of individual turns of wire, which imposes certain limits on the achievable accuracy and precision of coil manufacture using this technique.

U.S. Pat. No. 6,153,885 discloses a toroidal-type deflector exhibiting an improved positional accuracy of the deflector coil. The deflector includes multiple independent coil “vanes.” Each vane typically includes two coils that are mirror images of each other and that are situated on opposite sides of the vane. Each “vane” is a planar, electrically insulative, substrate member. The coils are wound individually in a spiral manner on the vanes and are connected electrically to each other. In this structure each coil exhibits high mechanical stability and accuracy.

Because a coil generates a magnetic field whenever an electrical current is passed through the coil, it is desirable that the transverse (cross-sectional) area of a conductor of the coil be as large as possible to reduce the electrical resistivity of the coil. Various attempts have been made at manufacturing coils having such conductors. For instance, U.S. patent application No. 09/471,613 by the instant Applicants discloses a coil fabricated as a thin copper layer formed on an alumina substrate by electroless plating. After forming the copper layer, a thin layer of resist, patterned in the shape of a coil, is applied to the copper by photolithography. The resist is used as a mask, the copper layer to which the resist is applied is used as a plating electrode, and a thick copper layer is formed by electroplating on “exposed” regions of the copper layer. A disadvantage of this method stems from its use of a thin resist layer, which makes it difficult to make coil conductors having steep side-wall angles.

In another method, disclosed in U.S. patent application No. 09/325,162, a copper layer, patterned in the shape of a coil, is mechanically aligned on a substrate and bonded to the substrate using an adhesive having a low coefficient of thermal expansion. A disadvantage of this method stems from use of the adhesive, which has a different coefficient of thermal expansion than either the substrate or the copper. Whenever the coil experiences a temperature increase, the resulting different thermal expansions exhibited by the copper, adhesive, and substrate cause undesirable positional changes of the coils.

In yet another method, disclosed in U.S. patent application No. 09/589,399, a copper layer formed on a substrate is worked by laser machining. Unfortunately, laser machining does not yield coil conductors having the required dimensional tolerances.

In general, the greater the number of coil windings (i.e., the greater the number of ampere turns), the larger the resulting magnetic field that can be produced by the coil. For optimal conductivity of conductors used in a coil, it is desired that the cross-sectional area of each conductor be maximized and that the coil density be maximized. It also is desirable that the sides of the transverse profile of the conductor be as steep as possible (i.e., at or near 90° relative to the width of the conductor) to allow a maximal number of coil windings per unit area of coil, and a corresponding increase in the coil density. Steep side-walls allow the width of each conductor to be maximized (resulting in greater cross-sectional area per coil) and the gap between adjacent conductors to be minimized (resulting in greater coil density).

Unfortunately, whenever coil patterning is performed by conventional lithographic methods, including methods as summarized above, it is difficult to achieve and maintain the desired verticality of the sides of a thick metal layer defining the conductors of the coil. The resulting laterally spread-out conductors do not have the desired cross-sectional area, which results in an unsatisfactorily high electrical resistance of the coil and/or increased difficulty of achieving a desired level of lithographic or imaging performance using the coil.

### SUMMARY

In view of the shortcomings of conventional methods as summarized above, an object of the invention is to provide coil-forming methods with which the accuracy of coil positioning is improved over conventional methods. Another object is to provide methods by which coils having greater coil density and comprising conductors having greater cross-sectional area than conventionally can be formed on a substrate.

To such end, a first embodiment of a method for manufacturing a coil for use in a CPB apparatus comprises as step in which a coil-pattern-defining mask is formed on a first surface of a coil substrate. The mask defines channels therein arranged in a desired pattern of coil conductors of a first coil and being configured to receive an electrically conductive coil-forming material. The channels extend through a thickness dimension of the mask at a depth that is greater than a desired thickness of the coil conductors to be formed in the channels. An electrically conductive coil-forming material is added (e.g., by electroplating) to the channels to form the coil conductors of the first coil.

In the foregoing method, the coil substrate desirably comprises a rigid, electrically insulative material such as glass, quartz, ceramic, or alumina. The coil-forming material desirably is a metal such as copper, silver, or gold.

The mask desirably is formed lithographically, and desirably comprises a developed photoresist. The channels defined by the mask desirably extend through the thickness dimension of the mask to the surface of the substrate. After forming the coil conductors, the mask desirably is removed.

The method can include the step of forming a second coil on a second surface of the substrate opposite the first surface. Desirably, the second coil is a mirror image of the first coil. With such a configuration, the first and second coils can be connected together electrically.

The method can further include the step, before the mask-forming step, of forming a layer of an electrically conductive substance, having a thickness that is relatively small compared to the intended thickness of the coil conductors, to the first surface of the substrate. The electrically conductive substance can be the same as the coil-forming material. The step of adding coil-forming material to the channels can comprise electroplating the coil-forming material in the channels, using the thin layer of electrically conductive substance as an electroplating electrode. The electrically conductive substance can comprise an “active” metal. Another method embodiment includes the step of forming, in at least a first surface of a coil substrate, coil-pattern-defining grooves that extend from the first surface into a thickness dimension of the coil substrate. The grooves can have a depth, in a thickness dimension of the substrate, greater than a desired thickness of the coil conductors to be formed in the grooves. The grooves can be formed by machining the respective surface of the substrate. An electrically conductive coil-forming material is added to the grooves so as to form conductors of the coil. The coil-forming material can be added to the grooves so as to fill the grooves completely. Alternatively, the coil-forming material can extend above the first surface of the substrate. In the latter instance, the method can include the step, after the step of adding coil-forming material to the grooves, of removing coil-forming material extending above the first surface of the substrate.

This method embodiment can further include the step of forming a second coil on a second surface of the substrate opposite the first surface. Desirably, the second coil is a mirror image of the first coil. The first and second coils can be connected together electrically.

In forming the first and second coils in this manner, they desirably are aligned with each other using a reference feature on the substrate, such as an alignment mark or a reference edge of the substrate.

In another embodiment of a method, on a first surface of an electrically insulative substrate, a first layer of an electrically conductive material is formed. The first layer is patterned to define a coil pattern in the first layer. A layer of a resist is applied, at a thickness of at least 0.1 mm, to the first layer. The layer of resist is patterned with a coil-defining pattern aligned with the coil pattern in the first layer. Resist is removed in regions where coil elements are to be located so as to expose the coil pattern in the first layer. Using the coil pattern in the first layer as a plating electrode, coil-forming material is caused to be deposited by electroplating on the first layer, to form coils having side-walls defined by edges of the resist. After forming the coils in this manner the resist is removed.

In yet another embodiment of a method, on a first surface of an electrically insulative substrate, a layer of a metallic material is formed. A layer of a resist is applied to the layer of metallic material, wherein the layer of resist has a thickness of at least 0.1 mm. The resist is patterned lithographically with a coil-defining pattern. Undeveloped resist is removed in regions on the first surface where coil elements are to be located, thereby producing exposed regions of the layer of metallic material where coil elements are to be located. In the exposed regions a coil-forming metal is electroplated from the exposed surface of the layer of metallic material, using the layer of metallic material as a plating electrode. Finally, the resist is removed.

In yet another method embodiment, on a first surface of an electrically insulative substrate, a conductive metal sheet is formed having a desired coil thickness. On the metal sheet, a mask is applied to regions where coil elements are to be located, thereby leaving unmasked regions of the metal sheet where coil elements are not to be located. Finally, metal of the metal sheet is removed in the unmasked regions. The conductive metal sheet can be formed by adhesion of a conductive metal sheet to the first surface. The metal can be removed by high-pressure spray etching or by sandblasting.

In this method coils can be formed on the top and bottom sides of the substrate, in which instance a two-side aligner can be used to position the lithography on the top and bottom sides.

In yet another method embodiment, on a first surface of an electrically insulative substrate, a conductive metal sheet is formed having a desired coil thickness. From regions of the metal sheet where coil elements are not to be located, material of the metal sheet is removed using a micro end mill. The working by the micro end mill leaves behind the lower part of the metal sheet, after which the remaining lower part of the metal sheet can be removed by etching.

The foregoing and additional features and advantages of the invention will be more readily apparent from the following detailed description, which proceeds with reference to the accompanying drawings.

### BRIEF DESCRIPTION OF THE DRAWINGS

FIGS. 1(a)-1(i) are elevational sections of a portion of a coil produced by a method according to a first representative embodiment, wherein each figure depicts the result of a respective step in the method.

FIGS. 2(a)-2(g) are elevational sections of a portion of a coil produced by a method according to a second representative embodiment, wherein each figure depicts the result of a respective step in the method.

FIGS. 3(a)-3(h) are elevational sections of a portion of a coil produced by a method according to a third representative embodiment, wherein each figure depicts the result of a respective step in the method.

FIGS. 4(a)-4(e) are elevational sections of a portion of a coil produced by a method according to a fourth representative embodiment, wherein each figure depicts the result of a respective step in the method.

FIGS. 5(a)-5(f) are elevational sections of a portion of a coil produced by a method according to a fifth representative embodiment, wherein each figure depicts the result of a respective step in the method.

FIGS. 6(a)-6(d) are elevational sections of a portion of a coil produced by a method according to a sixth representative embodiment, wherein each figure depicts the result of a respective step in the method.

FIGS. 7(a)-7(d) are elevational sections of a portion of a coil produced by a method according to an eighth representative embodiment, wherein each figure depicts the result of a respective step in the method.

### DETAILED DESCRIPTION

The invention is described and exemplified by the disclosure herein of representative embodiments that are not intended to be limiting in any way. Also, specific numerical values of process parameters disclosed in the various embodiments are exemplary only and are not intended to be limiting in any way.

First Representative Embodiment

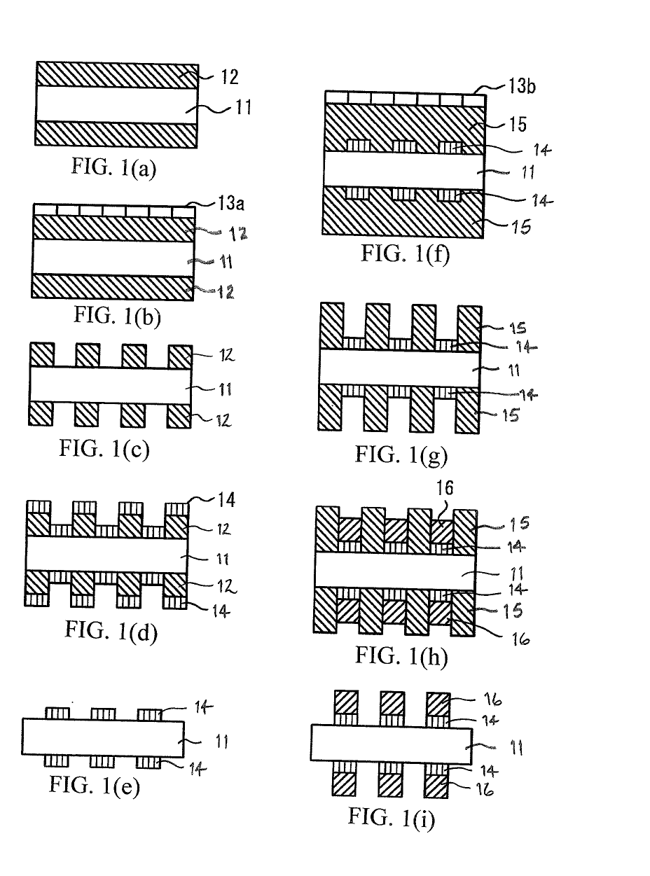

A first representative embodiment of a method for fabricating a coil is shown in FIGS. 1(a)-1(i), each depicting, in elevational section of a portion of the coil, the result of a respective step in the method.

Substrate: In this embodiment, a quartz substrate 11 is used. By way of example, the quartz substrate 11 is 100 mm in diameter and 2 mm thick. The surface of the substrate is smoothed to Ra 0.2 μm by grinding.

Resist-coating: A negative-exposure film (α450, made by Nihon Ohka, Japan) is applied to the surface on one side of the substrate 11, after which the substrate is “spun” (rotated about an axis perpendicular to the plane of the substrate) using a spinner. The resulting “spin-coating” uniformly coats the surface of the substrate 11 with a photoresist 12 at a thickness of 5 μm. The coated substrate is baked for 10 minutes in an oven at 80° C. After cooling to room temperature, the other side of the substrate 11 is coated with the photoresist 12 in the same manner (FIG. 1(a)).

Resist-exposure: Each photoresist layer 12 is exposed using, on each side of the coated substrate, a respective exposure mask 13 a defining a desired coil profile (FIG. 1(b), showing a mask 13a on only one side of the coated substrate). In each mask 13a, the coil profile is defined in the “opaque” portion of the mask (i.e., the portion of the mask that is opaque to exposure light). The mask 13a desirably is a glass dry plate symmetrically patterned with chromium on both sides. Exposure of both sides of the substrate is performed at an alignment accuracy of one side relative to the other of approximately 10 μm. This alignment accuracy is achieved using alignment marks on both sides of the substrate.

Resist-development: After exposure of the photoresist layers 12, the photoresist layers are developed using a developing solution to form the desired pattern in the photoresist layer (FIG. 1(c)).

Deposition of patterned thin-film copper electroplating electrode: A thin layer of copper 14 is vapor-deposited at a thickness of 500 to 1000 Angstroms on both sides of the substrate, according to the pattern in the photoresist layer 12 (FIG. 1(d)).

Resist-stripping: After depositing the thin layer of copper 14, the substrate is immersed in a liquid photoresist-stripper to remove residual photoresist from the substrate. This resist-stripping step also removes copper adhering to the photoresist but not the copper adhering to the quartz substrate. This residual copper forms the desired coil-shaped copper pattern on both sides of the substrate, wherein each conductor has a width of 0.6 mm and a thickness of 500 to 1000 Angstroms. This pattern of copper will be used as an electroplating electrode during a later copper-plating step. At this stage (FIG. 1(e)) the conductors of the coil patterns formed in the copper layer 14 are very thin (i.e., they have a very large transverse width compared to transverse height). Such a configuration, if used as a coil, exhibits a higher electrical resistance than desired. For use as a coil in a CPB optical system, it is desirable that the transverse height (thickness) of the conductors be increased relative to transverse width, thereby lowering the resistance of the coil. By way of example, the thickness of the conductors is increased to at least 0.1 mm. In order to lower the ratio of transverse width to height of the conductors, the thickness of the conductors is increased by applying or forming additional copper or other coil-forming material (e.g., silver or gold) in the thickness dimension on the copper conductors 14.

Conventional metal plating tends to proceed more in a lateral direction than in a thickness direction, which undesirably increases the transverse width of regions in which the metal is deposited. To prevent this problem, and according to an aspect of the invention, a thick-film mask is applied around the thin-film copper 14 already formed so as to promote the subsequent deposition of additional copper (as an exemplary coil-forming material) only in the thickness direction. This thick-film mask is applied by photolithography in the subsequent step.

Thick-film resist coating and exposure: To define regions in which a thick copper layer is to be formed, a thick layer 15 of a negative photoresist (e.g., SU-8, manufactured by Microchemical, Newton, Mass.) is applied to each surface of the substrate. The substrate is spun to coat its surface uniformly with the resist at a thickness of 0.6 mm. To such end, the spinning conditions are 5 to 15 seconds at a rotational velocity of 500 rpm, after which the rotational velocity is accelerated at 200 rpm/s² to 1200 rpm, at which spinning is continued for another 15 seconds. The resist 15 is baked for 10 minutes in an oven at 80° C., then cooled. A mask 13b, defining the same pattern as the exposure mask 13a used in a previous step, is applied (FIG. 1(f), showing the mask 13b on only one side of the coated substrate). The pattern in the mask 13b is aligned with the pattern in the initial thin-copper layer 14 at an accuracy of 1 to 2 μm using positioning marks on the substrate. The mask 13b is exposed using UV light of 350 to 400 nm at an exposure energy of 1300 mJ/cm² to imprint the mask pattern in the resist 15. After exposure, the resist-coated substrate is placed on an 80° C. hot plate for 5 minutes to cure the exposed resist 15.

Removal of uncured resist: The patterned thick-film resist layers 15 are allowed to cool naturally to room temperature, then placed in a solution that removes uncured resist. I.e., the solution removes resist 15 from the previously applied copper 14, but leaves the resist 15 in, for example, regions situated between the copper 14 (FIG. 1(g)). This remaining thick-film resist 15 serves as a mask during a subsequent copper-plating step.

Electroplating: Additional copper is applied to the “exposed” regions of copper 14 by electroplating. For electroplating one side of the substrate, the substrate is mounted in a plating jig, contact points of the patterned thin-film copper 14 are connected to a power source, and a plating pretreatment is conducted. Plating pretreatment includes cleaning off residual resist, then cleaning the surface using a regimen of exposure to aqueous HCl, soft-etching using sodium persulfate, then exposure to aqueous H₂SO₄. After pretreatment, plating is performed for 14 hours in a copper-plating solution mainly comprising copper sulfate. Plating is performed at an exemplary calculated current ratio of 3 amperes per 100 cm², which forms a layer 16 of copper having a thickness of 0.5 mm extending from the previously applied copper 14 on the substrate (FIG. 1(h), showing plating performed on both sides of the substrate). Note how the resist 15 produced very steep (substantially 90° relative to the plane of the substrate 11) sidewalls on the copper conductors 16.

Resist-stripping: After plating one side of the substrate, the substrate is immersed in a liquid photoresist stripper to remove residual photoresist from the plated side, thereby completing formation of the coil on that side. The coil on the other side is electroplated in a similar manner, thereby yielding a symmetrical configuration of relatively thick copper coils on both sides of the quartz substrate (FIG. 1(i)).

The conductors of the coils now have a transverse profile in which the thickness (height) is nearly equal to the width. This configuration, in which the aspect ratio is nearly unity, provides a more stable coil performance and allows a higher packing density of coil windings per unit area of coil.

Although quartz is used as the substrate 11 in this embodiment, a ceramic such as alumina, having a low coefficient of thermal expansion, alternatively can be used. Candidate alternative substrate materials include SiN, ZrO₂, AlN, BN, and glass. Also, although the thin copper layer 14 was formed by vapor deposition in this example, it alternatively can be formed by electroless plating or other suitable method.

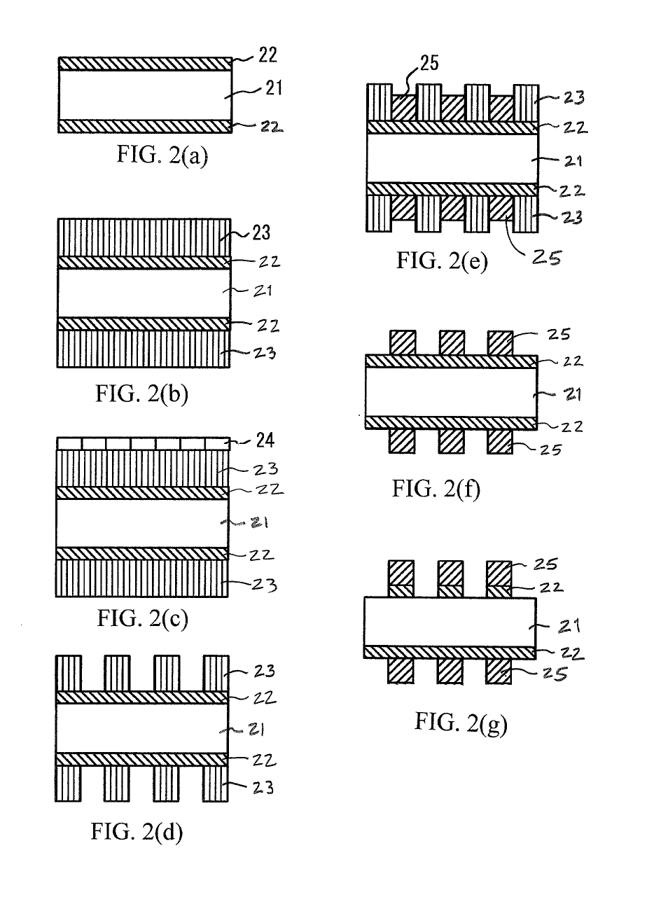

Also, the thick copper layer film 16 was electroplated by using the thin copper layer 14 as a plating electrode in this embodiment. However, patterning the thin copper layer 14 ahead of time may cause current flow in the copper layer 14 to be restricted locally during use as an electroplating electrode, causing a non-uniform deposition of the relatively thick copper layer 16. If such non-uniformity occurs or is a problem, the step involving deposition of the thin copper layer 14 alternatively can involve active-metal deposition as described in the second representative embodiment and shown in FIGS. 2(a)-2(g).

Second Representative Embodiment

Formation of active-metal layer: A layer 22 of “active” metal paste is applied on both sides of an alumina substrate 21. This active-metal paste contains Cu, Ag, and Ti. By “active” is meant that the paste facilitates bonding between the Ti and the substrate. Each layer has a thickness of about 20 μm. The layers are baked at 800 to 900° C. (FIG. 2(a)) to bond the layers 22 to the substrate.

Thermal bonding in this manner prevents the coils, formed later, from detaching from the substrate. Whenever alumina is used as the substrate 21 and copper is used for the electroplating electrode, for example, the bonding temperature in this step can be lower than otherwise would be required to bond copper to alumina by eutectic bonding. Since metal used for making electrodes can deteriorate at high baking temperatures, it is desirable that the baking temperature be as low as possible. See Japan Kôkai Patent Document Nos. Hei 6-264220 and Hei 6-5763.

Application of thick-film resist: A layer 23 of negative photoresist (e.g., SU-8, made by Microchemical) is applied to each surface of the substrate 21. The thickness of each resist layer 23 is reduced (to 0.6 mm) and made uniform by spinning the substrate 21. Exemplary spinning conditions are 5 to 15 seconds at a rotational velocity of 500 rpm, followed by acceleration at 200 rpm/s² to 1200 rpm, at which spinning is continued for another 15 seconds. The resist 23 is baked for 10 minutes in an oven at 80° C. The substrate is removed from the oven and cooled (FIG. 2(b)).

Resist-exposure: A mask 24 is formed on the surface of the resist 23 (FIG. 2(c), showing the mask 24 applied only to one side). The mask 24 defines a coil pattern such as that used in the first representative embodiment and includes positioning marks. On both sides of the substrate, the alignment accuracy of the pattern of the mask 24 is between 1 and 2 μm. Using the masks 24 as an exposure mask, the photoresist layers 23 on the substrate are exposed using UV light of 350 to 400 nm and an exposure energy of 1300 mJ/cm², for example. After exposure, the substrate is placed on an 80° C. hot plate for 5 minutes (FIG. 2(c)).

Removal of uncured resist: The exposed resist layers 23 are allowed to cool naturally to room temperature, then the substrate is placed in a solution that removes uncured resist. Thus, resist 23 is removed from regions of the active metal layer 22 where the coils are to be formed. Cured resist remains in regions where further copper deposition is not desired, and thus serves as a mask during a subsequent copper-plating step (FIG. 2(d)).

Electroplating: The substrate is mounted in a plating jig, contact points of the active metal layer 22 are connected to a power source, and a plating pretreatment is performed. Plating is then performed for 14 hours in a copper-plating solution mainly comprising copper sulfate. An exemplary calculated plating current is 3 amperes per 100 cm , which forms a relatively thick (0.5 mm) copper layer 25 over exposed regions of the active metal layer 22 (FIG. 2(e)).

Resist-stripping: After plating, the substrate is immersed in a photoresist-stripping liquid to remove residual photoresist 23 from the substrate (FIG. 2(f)).

Etching: The substrate is subjected to physical etching such as anisotropic honing or bombardment, or is immersed in a chemical etching solution, to remove exposed regions of the active metal layer 22 (i.e., regions other than where the coils are to be formed). Thus, unnecessary active metal 22 is removed (FIG. 2(g), showing the results of etching on only one side of the substrate). A small amount of copper also is removed by this etching from exposed surfaces of the copper layer 25. However, this poses no problem with excess removal of metal because the active-metal layer 22 is sufficiently thin compared to the copper layer 25 that only limited etching is required.

Third Representative Embodiment

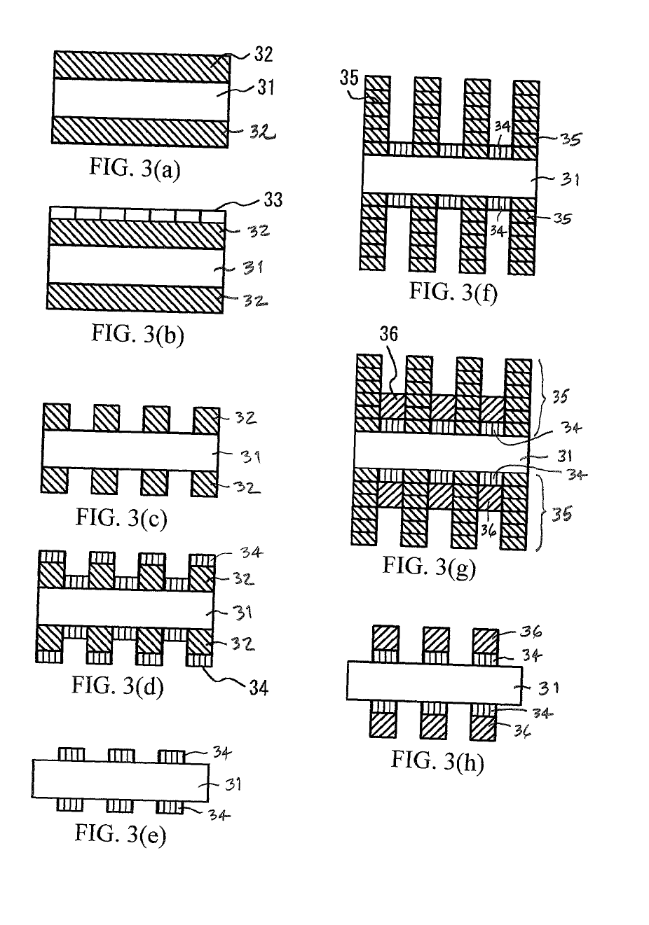

The respective results of steps of a method according to this embodiment are shown in FIGS. 3(a)-3(h).

By way of example, the substrate 31 used in this embodiment is a unit of quartz 100 mm in diameter and 2 mm thick. The surface of the substrate 31 is smoothed to Ra 0.2 μm by grinding.

The steps for producing on the substrate 31 the electrodes necessary for electroplating are the same as in the first representative embodiment, except that stereolithography is used for the masking that promotes the deposition of copper plating only in the thickness direction. In other words, the steps shown in FIGS. 3(a)-3(e) are the same as the steps shown in FIGS. 1(a)-1(e), respectively. Accordingly, FIGS. 3(a)-3(e) are not described below. The description starts at the step shown in FIG. 3(f).

Stereolithography: The substrate of FIG. 3(e) is immersed in a resin (such as a radical polymerizable acrylate-based resin) contained in a resin tank of a stereolithography apparatus. The immersion depth is 0.1 mm from the surface of the resin, with the front side of the substrate 31 (i.e., side on which stereolithography will be performed) facing upward. Next, a narrow light beam is scanned across the upward-facing surface, according to graphic data corresponding to the desired coil shape, forming a first cured layer 35 of resin. The first layer 35 of cured resin thus has a pattern profile defining regions situated between copper-plated regions 34 on the substrate 31 where additional copper is to be deposited. After forming one layer 35 of cured resin in this manner, the substrate is left oriented in the same manner while being immersed again in the liquid resin to a depth 0.1 mm from the surface of the previously formed resin layer. Another cured layer 35 of resin is formed in the same manner described above. This process is repeated four more times to form a total of six layers 35 of cured resin having a collective thickness of 0.6 mm. This same procedure is repeated to form a stack of six cured resin layers 35 on the other side of the substrate (FIG. 3(f)). The stacked resin layers serve as masks during a subsequent copper-plating step.

Electroplating: The resin-coated substrate is mounted in a plating jig, contact points of the thin-film copper layer are connected to a power source, and a plating pretreatment is performed. Copper plating is performed for 14 hours in a copper-plating solution mainly comprising copper sulfate, at an exemplary calculated current of 3 amperes per 100 square centimeters. Thus, a layer 36 of copper plating having a thickness of 0.5 mm is formed on the thin copper layer 34 in the unmasked regions (FIG. 3(g), not drawn to scale).

Resin-stripping: After completing copper plating, the substrate is immersed in a resin-stripping liquid to remove the residual resin from the substrate, thereby completing fabrication of the coil (FIG. 3(h)).

Fourth Representative Embodiment

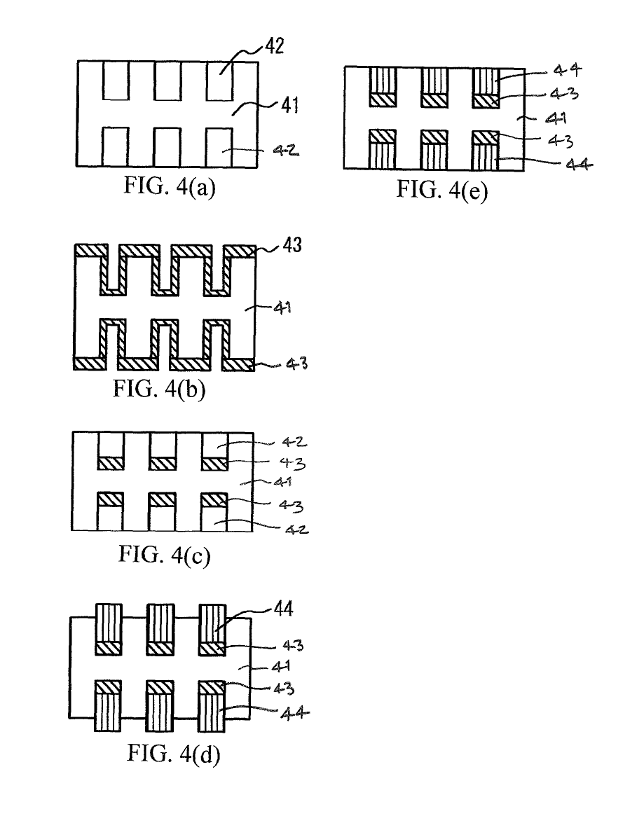

This embodiment is depicted in FIGS. 4(a)-4(e) depicting the results of respective steps of the method. In this embodiment the substrate 41 is a machinable ceramic.

Machining of grooves: Grooves 42 are cut into the surface of the substrate on one side of the substrate 41 using a grinding tool or the like (FIG. 4(a)). The grooves 42 are cut based on a specific machining program for machining the grooves having the same shape and profile as the desired coils to be formed on the substrate 41. The grooves are cut from a predetermined reference position on the substrate 41. Exemplary groove dimensions are 0.6 mm wide and 0.5 mm deep, with vertical side-walls. Next, corresponding grooves 42 having the same dimensions are cut into the surface of the other side of the substrate, such that the grooves have mirror-image symmetry on the two surfaces. The positional accuracy of the grooves on both sides of the substrate is approximately 10 μm. The reference position may be, for example, a reference through-hole extending through the thickness dimension of the substrate. Alternatively, if the edge verticality of the substrate is sufficiently accurate, then one or more edges of the substrate may be used as respective reference positions.

Vapor deposition: Copper 43 is vapor-deposited at a thickness of 500 to 1000 Angstroms on both sides of the substrate to form electroplating electrodes. To form the desired coils in a subsequent step, the copper at the bottom of the grooves 42 must have an appropriate thickness. Consequently, this step can result in copper being plated on the side-walls of the grooves (FIG. 4(b)).

Electrode formation: The substrate in the condition shown in FIG. 4(b) could result in copper being deposited, in the subsequent electroplating step, in undesired locations or in an undesirable manner. Consequently, in this step, all the copper 43, except at the bottom of the grooves 42, is removed. First, any copper deposited on the surface of the substrate 41 is removed by polishing. Copper on the side-walls of the grooves 42 is removed by direct machining according to a machining program. These steps result in copper 43 remaining only at the bottoms of the grooves 42 (FIG. 4(c)). This residual copper serves as a plating electrode in a subsequent copper-plating step.

Electroplating: The substrate is mounted in a plating jig, contact points of the copper 43 inside the grooves 42 are connected to a power source, and a plating pretreatment is performed. Afterwards, copper plating is performed for 14 hours in a copper-plating solution mainly comprising copper sulfate, at an exemplary calculated plating current of 3 amperes per 100 cm². The resulting copper layer 44 has a thickness of 0.5 mm (FIG. 4(d)).

Polishing: After plating, any deposited copper protruding from the substrate surface is removed by polishing. This completes fabrication of the coil (FIG. 4(e)).

In this embodiment the “height” (thickness) of the electroplated copper plating film 44 (FIG. 4(d)) is greater than the depth of the grooves, and copper extending above the surface of the substrate can be removed by polishing. To avoid this polishing step, the height of the coils may be controlled by increasing the groove depth and/or controlling the duration of copper-plating deposition. Also, whereas polishing is used to remove excess copper, the excess copper alternatively can be removed by any of various other mechanical working techniques.

Fifth Representative Embodiment

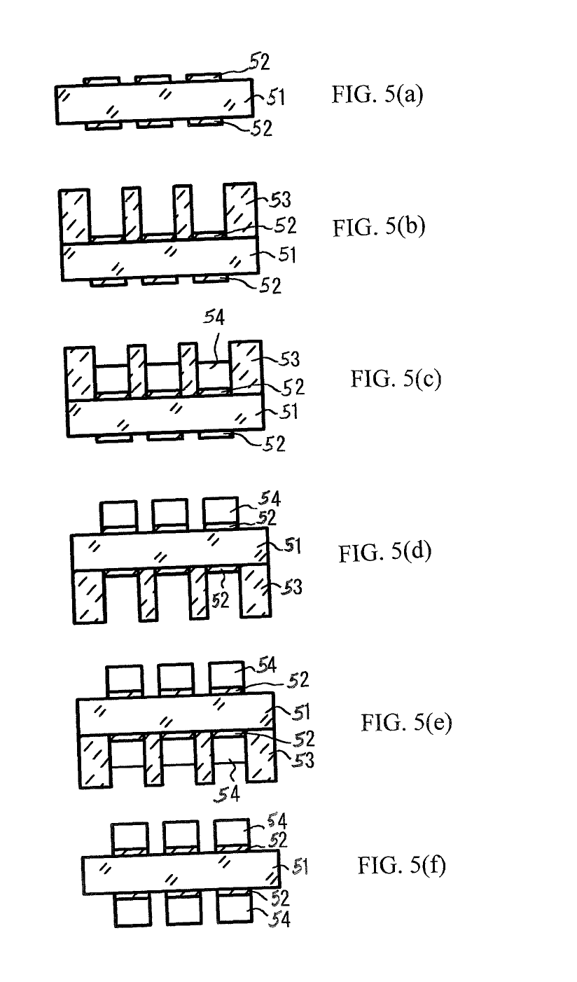

This embodiment is described with reference to FIGS. 5(a)-5(f). In this embodiment, the coil is made by electroplating using a thick-film resist. By way of example, quartz is used as a substrate 51 because this material is an electrical insulator and is thermally stable. Any of various other substrate materials can be used that are electrical insulators and that have low coefficients of thermal expansion, e.g., alumina.

Formation of electroplating electrodes: Electroplating electrodes are formed from relatively thin respective silver layers 52 patterned on the “top” and “bottom” surfaces of the substrate 51 by photolithography (FIG. 5(a)). A two-side “aligner” (lithography tool) desirably is used for patterning of the silver layers 52, so as to achieve an in-plane patterning accuracy of 1 to 2 μm, and a pattern-alignment accuracy between the top and bottom sides of about 10 μm.

Thick-film resist application and electroplating: The top-side of the substrate 51 is coated with a thick-film resist 53 at a thickness of 0.5 mm. The resist is patterned lithographically so as to mask everything but regions in which coils are to be formed (FIG. 5(b)). By way of example, the width of each coated region is 0.25 mm, and the width of the openings in the resist is 0.5 mm. The entire substrate is immersed in a plating solution containing copper ions, and an electrical current is passed through the silver pattern 52 to electroplate a copper layer 54 to a thickness of 0.4 mm (FIG. 5(c)).

In this step, the plating current and duration of plating can be controlled to adjust the thickness of the deposited copper 54 to a predetermined thickness of about 10 μm. Since ordinary electroplating proceeds anisotropically, it is desirable to perform electroplating in the presence of the thick-film resist 53 because, otherwise, the electroplating also would proceed laterally, which would destroy the desired verticality of the side-walls of the deposited copper 54 and cause excessive transverse flattening of the deposited copper. Thus, the copper coils 54 having the desired aspect ratio can be formed with high accuracy by limiting (using the thick-film resist 53) the growth direction of electroplating in the lateral direction.

Resist stripping and thick-film resist application: Residual resist 53 is removed from the electroplated top-side of the substrate 51, and a thick-film resist 53 is applied to the bottom side of the substrate in the same manner as described above (FIG. 5(d)).

Electroplating of bottom side: The bottom side of the substrate is electroplated with copper 54 in the same manner as described above (FIG. 5(e)).

Resist stripping: Residual resist 53 is removed from the bottom electroplated side of the substrate, yielding a highly accurate coil pattern of copper 54 on both sides of the substrate. The copper coils each have a transverse profile in which the ratio of width to height is approximately unity (FIG. 1(f)).

In this embodiment, as an alternative to silver 52, any of various other materials may be used (e.g., copper, gold, zinc, indium, platinum, molybdenum, tungsten, tantalum, palladium, aluminum, and non-magnetic nickel phosphorus) so long as the selected material bonds well to the substrate 51, has a suitably low electrical resistivity, and is non-magnetic. Candidate deposition methods include (but are not limited to) vaporization, electroless deposition, chemical plating, chemical vapor deposition, physical vapor deposition, ion plating, and sputtering. Also, any of various other materials (e.g., gold, zinc, indium, platinum, molybdenum, tungsten, tantalum, palladium, or aluminum) can be used as an alternative to the copper 54 so long as the material can be electroplated, has a suitably low electrical resistivity, and is non-magnetic.

In this embodiment the silver layers 52 were formed by lithographic patterning. However, from the standpoint of using this layer 52 as an electroplating electrode during a subsequent electroplating step, it may be desirable that the patterning not be performed at first, and that the metal 52 be removed after it has fulfilled its role as the electroplating electrode. In other words, the silver layers 52 can be provided over the entire surface of the substrate 51, up to the step shown in FIG. 5(f), and then removed by wet etching or the like after the thick copper layers 54 have been formed.

It is also possible for the thick copper layers 54 to be etched. If the silver layers 52 are relatively thin (such as only a few μm) compared to the copper, then the resulting slight etching of the copper layers 54 will not present any problem with excess removal of conductor material.

Sixth Representative Embodiment

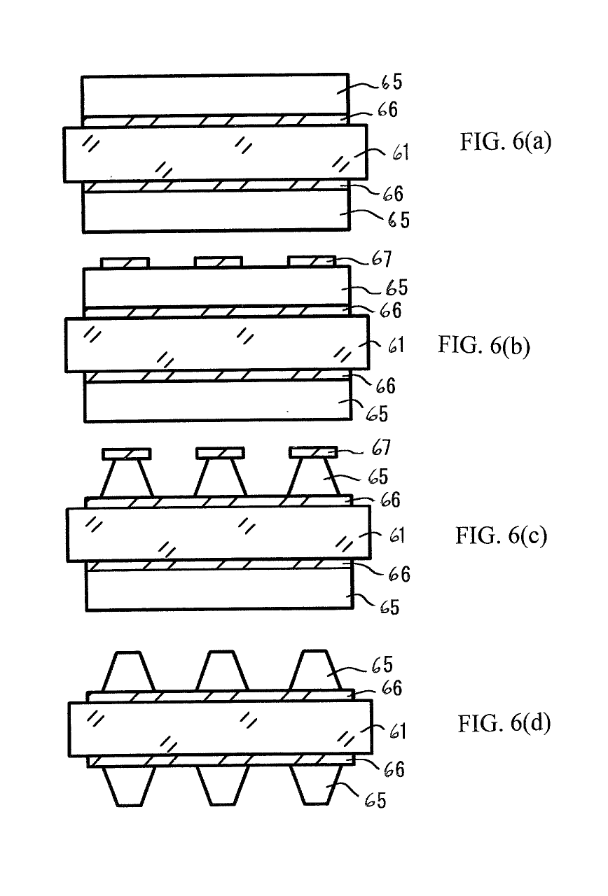

This embodiment is depicted in FIGS. 6(a)-6(d). In this embodiment the coils are formed by spray etching. A quartz substrate 61 is used as in the other representative embodiments. Copper sheets 65, each having a thickness of 0.4 mm, are bonded with an epoxy adhesive 66 to the top and bottom surfaces of the quartz substrate (FIG. 6(a)). The cured epoxy 66 desirably has the same low coefficient of thermal expansion as the substrate 61 and the copper 65. The top of the substrate 61 is coated with a layer 67 of resist that is patterned using an “aligner” (lithography tool) to leave exposed surficial regions of the copper 65 that are to be etched away (FIG. 6(b)). The top of the substrate is sprayed at high pressure with an etching liquid capable of etching copper (such as a ferric chloride solution), thereby etching away the exposed regions of copper (FIG. 6(c)). The use of high-pressure spray etching in this step forms steep sides of the etched copper. The copper sheet 65 is then patterned on the other side in the same manner FIG. 6(d)). Thus, the substrate 61 is provided with a highly accurate pattern of copper coils 65 having steep sides and the desired aspect ratio.

Seventh Representative Embodiment

This embodiment is similar to the sixth representative embodiment except that, in this seventh embodiment, the exposed copper 65 is sandblasted away rather than etched. Other steps in this embodiment are similar to corresponding steps in the sixth representative embodiment, except that the resist 67 used in the step shown in FIG. 6(b), is highly resistant to sandblasting. During sandblasting, residual grains of sand are blown off the surface of the substrate using compressed air, which also removes particles of copper dislodged by the sand (FIG. 6(c)). Sandblasting yields copper traces 65 having steep side-walls. Thus, a highly accurate coil having a large cross-sectional area is formed on the substrate (FIG. 6(d)).

Eighth Representative Embodiment

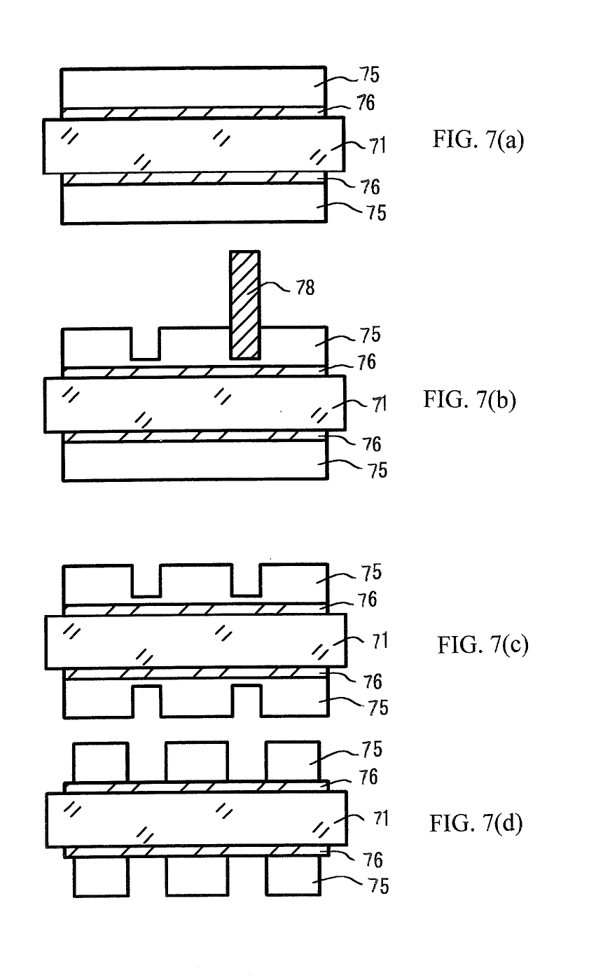

This embodiment is depicted in FIGS. 7(a)-7(d). In this embodiment, the coil is formed by machining a copper sheet (attached to the substrate) using a micro end mill. As in the sixth and seventh representative embodiments, epoxy adhesive 76 is used to bond copper sheets 75 (each having a thickness of 0.4 mm) to the substrate 71 (FIG. 7(a)). The top surface of the substrate is machined into a coil pattern using a micro end mill 78 (FIG. 7(b)). The positional accuracy obtainable using this technique is about 10 μm. The “micro end mill” 78 referred to here is a machine having the same working principle as an ordinary end mill, but that utilizes an extremely narrow end-mill tool having a diameter of about 0.25 mm. Since the end-mill tool actually performs the working of the copper 75, the copper can be removed to a width of 0.25 mm.

As shown in FIG. 7(b), about 10 μm of the lowermost portion of the copper sheets 7 5 is left behind by the milling. The tool of the micro end mill 78 is so narrow that, if a change in the cutting resistance is experienced by the tool, such as whenever the tool cutting copper encounters the epoxy adhesive 76 or the substrate 71, then the cutting tool 78 may break. For this reason, care is expended to ensure that only the copper 75 is worked by the tool.

The other side of the substrate 71 is worked using the micro end mill 78 in the same manner as the top surface. The obtainable accuracy of working-position alignment using this technique is about 30 μm (FIG. 7(c)). Finally, a few surficial micrometers of copper 75 are removed by etching. This etching is sufficient to remove the residual copper on the bottoms of the grooves without removing excess metal from the copper conductors. The etching can be wet etching performed using ferric chloride solution or the like. In any event, the etching results in separation of the individual coil conductors from each other (FIG. 7(d)), while retaining the desired aspect ratio of the individual coil conductors.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A method for manufacturing a coil for use in a charged-particle-beam apparatus, comprising:
forming a coil-pattern-defining mask on a first surface of a coil substrate, the mask defining channels therein arranged in a desired pattern of coil conductors of a first coil and being configured to receive an electrically conductive coil-forming material, the channels extending through a thickness dimension of the mask at a depth that is greater than a desired thickness of the coil conductors to be formed in the channels; and
adding an electrically conductive coil-forming material to the channels to form the coil conductors of the first coil.

2. The method of claim 1, wherein the channels extend through the thickness dimension of the mask to the surface of the substrate.

3. The method of claim 1, further comprising the step, after forming the coil conductors, of removing the mask.

4. The method of claim 1, wherein the mask is formed stereolithographically.

5. The method of claim 1, wherein the mask comprises a developed photoresist.

6. The method of claim 1, further comprising the step of forming a second coil on a second surface of the substrate opposite the first surface.

7. The method of claim 6, further comprising the step of electrically connecting the first and second coils together.

8. The method of claim 1, further comprising the step, before the mask-forming step, of forming a layer of an electrically conductive substance comprising an active metal, the layer having a thickness that is relatively small compared to the intended thickness of the coil conductors, on the first surface of the substrate.

9. A method for manufacturing a coil for use in a charged-particle-beam apparatus, comprising:
in at least a first surface of a coil substrate, forming coil-pattern-defining grooves extending from the first surface into a thickness dimension of the coil substrate; and
adding an electrically conductive coil-forming material to the grooves so as to form conductors of the coil.

10. The method of claim 9, wherein the coil-forming material is added to the grooves so as to fill the grooves completely.

11. The method of claim 10, wherein the coil-forming material extends above the first surface of the substrate.

12. The method of claim 11, further comprising the step, after the step of adding coil-forming material to the grooves, of removing coil-forming material extending above the first surface of the substrate.

13. The method of claim 9, further comprising the step of forming a second coil on a second surface of the substrate opposite the first surface, wherein the first and second coils are aligned with each other using a reference feature on the substrate.

14. The method of claim 9, wherein the grooves have a depth, in a thickness dimension of the substrate, greater than a desired thickness of the coil conductors to be formed in the grooves.

15. The method of claim 9, wherein the grooves are formed by machining the respective surface of the substrate.

16. A method for manufacturing a coil for use in a charged-particle-beam apparatus, comprising:
on a first surface of an electrically insulative substrate, forming a first layer of an electrically conductive material;
patterning the first layer to define a coil pattern in the first layer;
applying a layer of a resist, at a thickness of at least 0.1 mm, to the first layer;
patterning the layer of resist with a coil-defining pattern aligned with the coil pattern in the first layer;
removing resist in regions where coil elements are to be located so as to expose the coil pattern in the first layer;
using the coil pattern in the first layer as a plating electrode, causing coil-forming material to be deposited by electroplating on the first layer, to form coils having side-walls defined by edges of the resist; and
removing the resist.

17. A method for manufacturing a coil for use in a charged-particle-beam apparatus, comprising:
on a first surface of an electrically insulative substrate, forming a layer of a metallic material;
applying to the layer of metallic material a layer of a resist at a thickness of at least 0.1 mm;
stereolithographically patterning the resist with a coil-defining pattern;
removing undeveloped resist in regions on the first surface where coil elements are to be located, thereby producing exposed regions of the layer of metallic material where coil elements are to be located; in the exposed regions electroplating a coil-forming metal from the exposed surface of the layer of metallic material, using the layer of metallic material as a plating electrode; and
removing the resist.

18. A method for manufacturing a coil for use in a charged-particle-beam apparatus, comprising:
on a first surface of an electrically insulative substrate, forming a conductive metal sheet having a desired coil thickness;
on the metal sheet, applying a mask to regions where coil elements are to be located, thereby leaving unmasked regions of the metal sheet where coil elements are not to be located; and
removing metal of the metal sheet in the unmasked regions.

19. The method of claim 18, wherein the metal is removed by high-pressure spray etching.

20. The method of claim 18, wherein the metal is removed by sandblasting.

21. A method for manufacturing a coil for use in a charged-particle-beam apparatus, comprising:
on a first surface of an electrically insulative substrate, forming a conductive metal sheet having a desired coil thickness; and
from regions of the metal sheet where coil elements are not to be located, removing material of the metal sheet using a micro end mill.

22. The method of claim 21, wherein the working by the micro end mill leaves behind the lower part of the metal sheet, after which the remaining lower part of the metal sheet is removed by etching.
